(19) United States
(12) Patent Application Publication
(10) Pub. No.: US 2026/0072774 A1
(43) Pub. Date: Mar. 12, 2026

(54) RELIABILITY PATTERN CLASSIFICATION SYSTEM AND METHOD

(71) Applicant: THE BOEING COMPANY, Arlington, VA (US)

(72) Inventors: Lakshmi Ethirajan, Bangalore (IN); Manoj Nath, Bangalore (IN); Rajkumar Srinivasan, Bangalore (IN); Sarin Kumar Thayyilsubramanian, Bangalore (IN); Jaya Garg, Bangalore (IN); Alex Bellemare-Davis, Richmond (CA); Tamila Kalimullina, Vancouver (CA); Nayef Ahmad, Toronto (CA)

(73) Assignee: THE BOEING COMPANY, Arlington, VA (US)

(21) Appl. No.: 18/827,339

(22) Filed: Sep. 6, 2024

(51) Int. Cl. G06F 11/07; G06F 18/22

(52) U.S. Cl. CPC G06F 11/0769; G06F 11/0721; G06F 18/22

(57) ABSTRACT

A reliability pattern classification system includes a communication device configured to obtain historical data indicative of usage of a component of a powered system, and a control unit that can create a visual representation of the historical data. The control unit also can identify one or more reliability patterns within the visual representation using a vision-based, deep learning model, categorize a failure mode of the component based on the one or more reliability patterns that are identified, and implement one or more responsive actions to change a state of condition of the component, the powered system, or both the component and the powered system.

### BACKGROUND

### Field of the Disclosure

Examples of the present disclosure generally relate to systems and methods that use machine learning to identify patterns in data.

### Description of the Art

Various systems can be complex with many different parts of equipment operating together or in parallel to perform work of the system. Over time, parts or equipment can wear down and fail if not properly maintained. Detecting, analyzing, and characterizing failure modes and reliability patterns are fundamental activities of reliability and maintenance engineering.

Typically, the failure modes and reliability patterns are identified by examining historical data of the parts and equipment, such as maintenance records. For example, time series analysis, regression analysis, and survival analysis can be used to identify trends, patterns, and potential failure modes. The reliability data for parts can be measured through lifetimes of the parts (e.g., time in service, such as time-on-wing for aircraft equipment) and may be characterized though simple aggregate parameters (e.g., mean-time-between-unscheduled-removal), parametric fits (e.g., Weibull models), or non-parametric models (e.g., Kaplan-Meier analysis), depending on the business case.

Simple aggregate parameters such as mean-time-between-failures (MTBF) are robust, can require very little computer memory to complete, and can monitor approximate changes in behavior, but provide very little information about the underlying reliability behavior itself. The non-parametric models can provide rich, empirical models regardless of the amount of available data, and can be valuable for making predictions. But these models can be computationally expensive (e.g., because the model cannot be reduced to parameters), and the models are difficult to qualitatively characterize. The more sophisticated parametric models (e.g., unimodal Weibull) can be valuable because the parameters of the models can be used to make qualitative labels (e.g., the Weibull shape parameter) and the models are computationally inexpensive, but these models may only function when the reliability patterns obey the assumptions endemic to that choice of model (e.g., the physics of the failure modes and the number of the failure modes). Additionally, performance of these models can be very sensitive to the amount of available data. All of these options tend to require manual expert inspection to make judgments or validate labels, which can be untenable at large scales. Alternatively, one can accept large error rates, which are likewise painful at scale.

Some known machine learning algorithms for numeric classification of data may require fixed length input features for each datapoint. But, if the input data varies in length for each part or equipment being examined, the data may need to be converted to a fixed size (e.g., using truncation or padding). Truncation leads to loss of information from the data and padding can introduce noise into the data. Another option is to aggregate the data based on the distribution of the data. But this also can lead to a loss of information in the data.

While these abovementioned known methods for identifying failure modes and reliability patterns can be used, qualitative characterization is a capability that is both desirable and historically difficult to deliver with these known methods. Qualitative characterization strives to label the reliability behavior of the part or equipment according to an actionable label (e.g., wear-out failure, early mortality, manufacturing defect or installation error, separately and in combination, etc) by which large volumes of parts and equipment can be sorted, sliced, and filtered. This permits quick identification of groups of components (e.g., parts or equipment) for analysis and action.

But, no adequately versatile or dependable system or method is known to characterize reliability patterns, which means that reliability labels that are provided by known systems and methods often exhibit false positives and false negatives. This results in wasted opportunity and considerable manual checking. As there are many thousands of components and parts within some systems (e.g., there may be hundreds of thousands, or even millions, of parts onboard a modern aircraft), the frustration of waste can be considerable. However, although difficult to express numerically, reliability experts can manually assess the patterns of interest and assign labels from visual representations of the data. A system that emulates this manner of vision-based classification at scale can overcome the limitations of existing solutions.

### BRIEF SUMMARY

One example of a reliability pattern classification system includes a communication device configured to obtain historical data indicative of usage of a component of a powered system, and a control unit that can create a visual representation of the historical data. The control unit also can identify one or more reliability patterns within the visual representation using a vision-based, deep learning model, categorize a failure mode of the component based on the one or more reliability patterns that are identified, and implement one or more responsive actions to change a state of condition of the component, the powered system, or both the component and the powered system.

One example of a method includes obtaining historical data indicative of usage of a component of a powered system, creating a visual representation of the historical data, identifying one or more reliability patterns within the visual representation using a vision-based, deep learning model, categorizing a failure mode of the component based on the one or more reliability patterns that are identified, and implementing one or more responsive actions to change a state of condition of the component, the powered system, or both the component and the powered system.

Another example of a method includes creating visual representations of raw maintenance data of components of an aircraft, visually identifying patterns within the visual representations using a vision-based, deep learning model, categorizing the components into different failure modes based on the patterns that are visually identified, and changing a state of the aircraft based on at least one of the failure modes into which at least one of the components is categorized.

As descried herein, using a deep learning, artificial intelligence-powered system can learn the most actionable or useful qualitative labels that reliability engineers would themselves manually apply to visual data, but also apply those labels at large scales. This can deliver the exact same value that human analysts provide, but on volumes of data and at speeds or at frequencies that humans cannot practically achieve.

### BRIEF DESCRIPTION OF THE DRAWINGS

FIG. 1 illustrates one example of a reliability pattern classification system.

FIG. 2 illustrates a flowchart of one example of a method for classifying reliability patterns.

FIG. 3 illustrates examples of visual representations of raw data.

FIG. 4 illustrates additional examples of reliability patterns.

FIG. 5 illustrates additional examples of reliability patterns.

FIG. 6 illustrates one example of a powered system.

### DETAILED DESCRIPTION

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

As described herein, a failure can be any observed or discovered unreliability event of interest, whether electronically logged faults or indications, deviations from specification, degradations beyond tolerance, nonconformances, or other loss of designed function. A failure may generally require a maintenance action to repair, replace, or otherwise restore the system to full, nominal operating function. A failure mode may refer to one of multiple quantitatively distinct unreliability features in a reliability pattern comprising a trend (such as an infant/early mortality feature, a wear-out feature, a random failure feature, or the like) and/or a known physical reason producing the quantitative feature (such as known defects, installation errors, metal fatigue, wear beyond limits, etc.), producing the failure(s) of interest. The failure modes can be labeled by shape and/or properties (e.g., infant mortality, a first type of wear out, a different, second type of wear out, etc.). In some examples, the failure modes can be labeled by known or dominant causal factors of the failure, such as a defect caused by or originating at a supplier of the component, an error that occurred during installation (e.g., improper or incorrect installation, damage to the component caused during installation, etc.). Other failure modes can be labeled by known or diagnosed physical failures associated with the failure modes, such as leaks, metal fatigue, etc.). A reliability pattern can be the probability of failure of a component as a function of one or more operational variables of the component. These operational variables can include operating time (e.g., flight time) of the component or powered system, operational cycles or duty cycles of the component or powered system (e.g., the number of flights), landings of the powered system (e.g., as an aircraft), age (e.g., calendar days since installation or manufacture of the component), throttle settings, electric load, or the like. The operational variables can indicate the age, the amount of usage, and/or the load placed on the component, with different values of the operational variables indicating different ages, different amounts of usage, and/or different loads placed on the component. In one example, a reliability pattern can include multiple additive and superimposed sub-patterns each indicative of a distinct (e.g., different) failure mode.

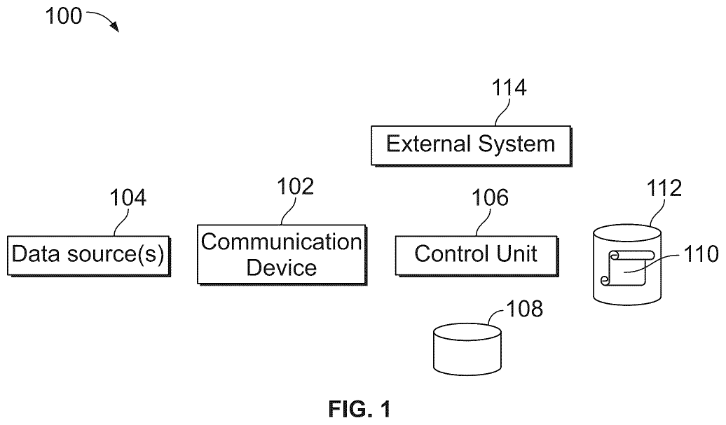

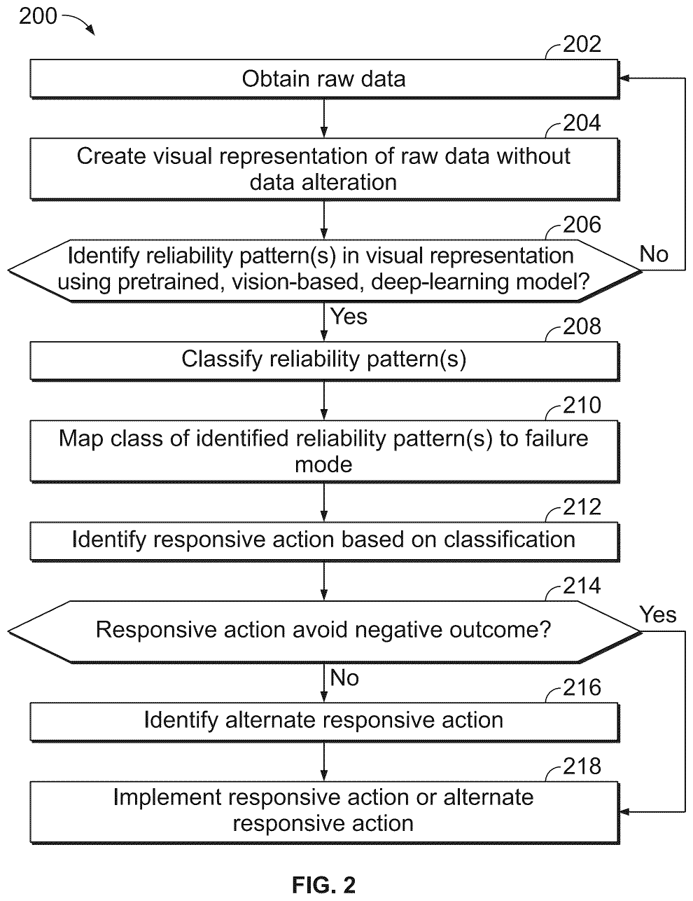

FIG. 1 illustrates one example of a reliability pattern classification system 100. FIG. 2 illustrates a flowchart of one example of a method 200 for classifying reliability patterns. The operations described in the flowchart of the method 200 may be performed by the classification system 100. At 202, raw data is obtained. This data can be historical data about parts of equipment for a powered system, such as an aircraft. While several examples provided herein relate to aircraft, not all embodiments of the inventive subject matter may be limited to aircraft. For example, the inventive systems and methods described herein may be used to identify reliability patterns, classify the patterns, and determine responsive actions for maintenance of powered systems other than aircraft, such as automobiles, mining vehicles, power plants, medical equipment, or the like.

The raw data may be maintenance data indicative of usage, operation, maintenance, inspection, and/or repair of components of a powered system. The raw data may be primary data, and can represent operational usage variables (e.g., values indicating service lives of the parts or equipment, duty cycles, etc.). With respect to aircraft, the raw data can include flight hours (e.g., the length of time that the part or equipment has been onboard a flying aircraft), flight cycles (e.g., the number of flights that the part or equipment was onboard the aircraft), days on wing (e.g., the length of time that the part or equipment has been onboard the aircraft including during flight and while grounded), or the like. The raw data may be obtained from documented histories of repair and upkeep performed on the part or equipment. Optionally, the raw data can include information such as maintenance tasks performed on the part or equipment, measurements of characteristics of the part or equipment (e.g., temperatures, pressures, decibel levels, viscosities, dimensions, outputs, vibrations and/or accelerations, etc.), consumables or materials used in the maintenance, dates or times of the maintenance, structured or unstructured data from personnel performing the maintenance, or the like. The raw data that is obtained may be data from not only the part or equipment being examined for reliability patterns, but also from other parts or equipment of the powered system (as a failure mode or impending failure mode of another part may impact or advance the failure mode of the part or equipment being examined).

The raw data may be data that is unaltered. The raw data may be unprocessed information from the data source 104 or that is stored from the data source 104. The raw data obtained by the communication device 102 may not have been changed, formatted, altered, cleaned, sorted, converted, and/or structured following creation of the data. The data may not be normalized, truncated, scaled, weighted, or the like, before or after being received by the communication device 102. The data may be obtained by the communication device 102 with the same values, dates, etc. as the data was first or initially generated. Examples of the raw data can include measurements of the part or equipment, the dates on which maintenance was performed, the measurements of output(s) of the part or equipment, etc., may not be changed.

The raw data can be obtained by a communication device 102 from one or more data sources 104, such as computing devices and/or memory that stores maintenance logs, sensor data, or the like, associated with the parts and equipment of the powered system. The communication device 102 can represent one or more devices that can communicate with the data sources 104 via wired and/or wireless pathways, such as modems, antennas, transmitters, receivers, transceivers, etc. The communication device 102 can communicate with the data sources 104 via one or more computer networks. The data sources 104 optionally can represent the sensors or other devices that measure the parts or equipment and/or the outputs of the parts or equipment.

The communication device 102 may poll the data sources 104 for the data (e.g., on a repeated basis or on command by an operator). The data sources 104 may send the data to the communication device 102 (e.g., on a repeated basis or on command by an operator). As one example, the communication device 102 may receive data from one or more of the data sources 104 responsive to the data for a part or equipment being updated at that data source 104 or those data sources 104 (e.g., following a maintenance activity performed on a part or equipment). The term “component” is used herein to refer to a part or equipment of a larger powered system.

At 204 in the method 200, one or more visual representations of the raw data can be generated. The classification system 100 can include a control unit 106 that receives the raw data from the communication device 102 (or from a tangible and non-transitory computer readable storage medium, such as a computer memory 108, where the raw data is stored). The control unit 106 can represent hardware circuitry that includes and/or is connected with one or more processors (e.g., one or more microprocessors, integrated circuits, field programmable gate arrays, microcontrollers, etc.) that perform the operations described in connection with the control unit 106.

The control unit 106 can create a visual representation of the raw data. This visual representations can be line charts (data points representative of the values of the raw data with lines connecting the data points, such as connecting sequential pairs of the data points), column charts or bar charts (e.g., a histogram with bars of different heights or widths representing different values of the raw data), scatter plots (e.g., data points each representing a value of the raw data), box plots, cumulative distribution functions (CDF), probability density functions (PDF), both CDFs and PDFs, area charts (e.g., line chart with areas beneath the lines filled to represent different values of the raw data), pie charts, three dimensional or surface charts (e.g., showing raw data having three or more variables), radar charts or spider charts (e.g., data points on radial axes), or the like.

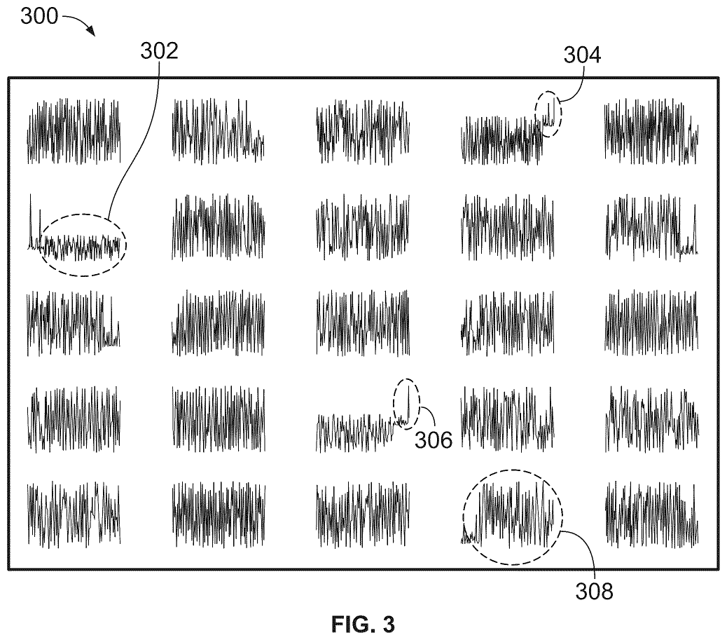

FIG. 3 illustrates examples of visual representations 300 of raw data. The visual representations 300 in FIG. 3 are line charts, but optionally may be another visual representation. The visual representation 300 plots the values of the raw data for a part or equipment. Each visual representation 300 shown in FIG. 3 (twenty-five in total) can represent the raw data from a different category for the same part or equipment. For example, one visual representation 300 can represent the raw values of the number of flight hours of the part or equipment, another visual representation 300 can represent the number of flight cycles of the same part or equipment, another visual representation 300 can represent the number of days on wing of the same part or equipment, etc. Other visual representations 300 can represent this raw data for other parts or other equipment. As another example, the line charts can represent sensor data from the same sensor at different times (e.g., different maintenance events or inspections), sensor data from different sensors that measured the same or different characteristics (e.g., temperatures, pressures, dimensions, sounds, etc.) of the same part or equipment at the same time or at different times, or a combination thereof. Optionally, two or more of the visual representations 300 shown in FIG. 3 may represent the raw data for different parts or equipment (e.g., temperatures measured for different parts). The visual representations 300 created by the control unit 106 can be stored in the memory 108 or in another location.

The visual representations 300 can be created by the control unit 106 without changing any of the raw data. For example, the control unit 106 can plot the values of the raw data for two or more characteristics, for two or more parts, etc. in different visual representations 300 without normalizing, scaling, truncating, or otherwise changing the raw data. The visual representations 300 may represent the exact same raw data that was received by the communication device 102.

Some potential failure modes may be visually identified in the data. For example, significant departures 302, 304, 306, 308 of the data in the representations 300 can indicate different failure modes and/or combinations of two or more of these departures 302, 304, 306, 308 can indicate different failure modes. These departures 302, 304, 306, 308 can indicate a decrease in the range over which the data extends and a decrease in the mean or median value (e.g., the middle of the range) of the data (e.g., the departure 302), a decrease in the range over which the data extends and an increase in the mean or median value of the data (e.g., the departure 304), a sudden and significant increase in the data (e.g., the departure 306), and an increase in the range over which the data extends and/or an increase in the mean or median value (e.g., the departure 308). Other examples of departures can include only a change in the range over which the data extends (e.g., an increase or a decrease such that the data is scattered over a wider range in the vertical axis as the increase or the data is scattered over a smaller range in the vertical axis as the decrease), a change in the mean or median value, or the like.

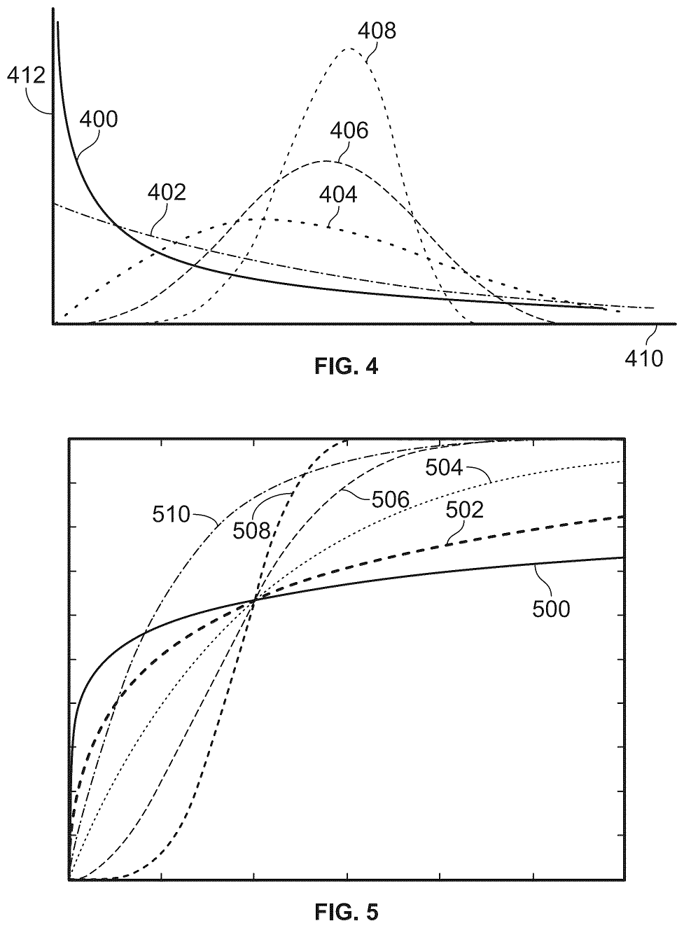

FIG. 4 illustrates additional examples of visual representations 400, 402, 404, 406, 408 of data. The visual representations 400, 402, 404, 406, 408 are examples of PDFs shown alongside a horizontal axis 410 representative of the values of the data and a vertical axis 412 representative of a likelihood of failure. The curves or shapes of the visual representations 400, 402, 404, 406, 408 represent different reliability patterns in one example. Each reliability pattern can represent or be associated with a different failure mode.

For example, the shape of the curve of the visual representation 400 can represent a reliability pattern associated with a failure mode driving infant mortality. The shape of the curve of the visual representation 402 can represent a reliability pattern associated with a failure mode of random failure. The shapes of the visual representations 404, 406, 408 can represent different reliability patterns associated with different failure modes, such different wear-out failure modes (each associated with a different physical cause of the wear-out).

FIG. 5 illustrates additional examples of visual representations 500, 502, 504, 506, 508, 510 of data. The visual representations 500, 502, 504, 506, 508, 510 are examples of Weibull distributions represented as CDFs. The curves or shapes of the visual representations 500, 502, 504, 506, 508, 510 represent different reliability patterns in one example. Each reliability pattern can represent or be associated with a different failure mode, similar to the visual representations shown in FIGS. 3 and 4.

Returning to the description of the flowchart of the method 200 shown in FIG. 2, at 206, the visual representation(s) are examined to determine whether any reliability patterns are identified. The control unit 106 can examine the visual representation(s) using a machine learning model 110 stored in a computer memory 112 (or stored in the memory 108). The machine learning model 110 may be trained (and re-trained) to identify different patterns in the visual representations. These different patterns can be referred to as reliability patterns, and can indicate the state or condition of the part or equipment being examined, as described below. The machine learning model 110 can identify multiple failure modes for a component or the powered system. Two or more of the patterns described herein may appear in the visual representation of the data as sub-patterns (either side-by-side, separated by a segment of the data that does not match a reliability pattern, or added together with one pattern superimposed on another pattern). The machine learning model 110 can visually distinguish the sub-patterns to label the sub-patterns distinctly as separate failure modes.

The model 110 can be used by the control unit 106 to identify reliability patterns in the visual representations. The control unit 106 can examine the visual representations to identify visual patterns (at 206 in the method 200) and, if one or more patterns are identified, classify the patterns (at 208 in the method 200). If no patterns are identified, then flow of the method 200 can return to another operation (e.g., 202) or can terminate.

Creating the visual representations from the raw data and then examining the visual representations instead of the raw data itself (e.g., instead of examining the values of the raw data) can ensure that all the raw data is considered and that there is no loss of information. Additionally, the visual representations can handle a wide range of different sizes of the raw data.

The classification of the patterns can be qualitative characterizations of the state of the part or equipment being examined. For example, the control unit 106 can identify a part or equipment as having a high likelihood (e.g., greater than a threshold likelihood which may depend on the criticality of the part or equipment) as being at risk of infant mortality, random failure, periodic failure, or wear-out failure. The infant mortality classification can indicate that the part or equipment is likely to fail early in its useful life, such as before a threshold amount of usage time or a threshold number of duty cycles. The random failure classification can indicate that the part or equipment is likely to fail without prior warning or indication (aside from the inventive subject matter described herein). The wear-out failure classification can indicate that the part or equipment is likely to fail due to extensive usage of the part or equipment, such as the part or equipment approaching the end of its useful life. The periodic failure classification can indicate that the part or equipment is likely to fail or breakdown at a predictable interval. Another classification can include a combination of other classes, such as an infant mortality classification and a wear out classification. Another classification can include an “all clear” classification, which can indicate that the part or equipment is not likely to experience infant mortality, random failure, or wear-out failure.

The model 110 can be trained with relevant, labeled visual representations of synthetic data and/or human-labeled data to recognize the physics of multiple popular parametric models and human expertise. For example, different parametric probability distributions (e.g., Weibull, Gaussian, Dirichlet, etc.) can be used to generate large volumes of synthetic data according to known parameters (e.g., various visual representations), which can then in turn be labeled according to the desired label or classification (e.g., infant mortality, random failure, periodic failure, or wear-out failure). The synthetic training data can be obtained from subject matter experts for the various parts and equipment, and heuristic rules can be included in the model 110 to identify or classify the different failure modes (e.g., infant failure, random failure, wear-out failure, periodic failure, or no failure). The control unit 106 can then use the model 110 to examine other visual representations (i.e., cohort data and not training data) and try to identify patterns in these visual representations that match or correspond to patterns in the visual representations from the training data.

The patterns can be different sections of the visual representations, such the length, angle, etc. of different lines or datapoints, the distribution or density of the lines or datapoints, etc. Different patterns can be associated with the different failure modes. At 208 in the method 200, a classification of the pattern(s) identified from the visual representation(s) of the cohort raw data is determined. The control unit 106 can use the model 110 to identify the classification of the training pattern that matches the cohort pattern in the visual representation(s) of the raw data from the part or equipment being examined.

In one example, the model 110 can be a previously trained vision-based deep-learning model. For example, the model 110 can be previously trained to merely identify shapes, sizes, densities, etc. appearing in an image or other visual representation. This model 110 can then be trained to identify the reliability patterns in the visual representations 300. Using a previously trained model can reduce the computational costs, the time to train the model 110, and the size of the training data when compared to creating the model 110 without using a previously trained model.

Operation of the model 110 can improve over time as more labeled examples are used to train the model 110. Additionally, additional failure mode classifications can be added to the model 110 as these classifications are discovered or learned. For example, with respect to aircraft, failure modes can change over time due to usage patterns, changes in technology, and human factors. The model 110 can adapt to these changing conditions through continuous updates as more data is accumulated. This ensures that detection of failure modes remains accurate and updated.

The control unit 106 can use the model 110 to examine the visual representations of the raw data for several parts and/or equipment of the powered system. The control unit 106 can categorize or bucketize the parts and/or equipment into different categories or buckets based on the classifications that are identified from the patterns found in the visual representations 300. For example, the control unit 106 can label all parts or equipment having a first pattern or combination of patterns found in the visual representations of those parts or equipment as being in a wear-out failure category or bucket. As another example, the control unit 106 can label all parts or equipment having a different, second pattern or combination of patterns found in the visual representations of those parts or equipment as being in an infant mortality failure category or bucket. As another example, the control unit 106 can label all parts or equipment having a different, third pattern or combination of patterns found in the visual representations of those parts or equipment as being in a random failure category or bucket. As another example, the control unit 106 can label all parts or equipment having a different, fourth pattern or combination of patterns found in the visual representations of those parts or equipment as being in a periodic failure category or bucket. The control unit 106 can label other parts or equipment not having these patterns or combinations of patterns in the visual representations of those parts or equipment as being in none of these categories or buckets, or can label the parts or equipment as being in a no-failure category or bucket.

In one example, the control unit 106 includes or represents an artificial neural network (ANN) that identifies patterns in the visual representations of data, classifies the patterns (e.g., assigns a class to an identified pattern, such as class #1, class #2, and so on) based on the contents of the patterns that are identified, and identifies one or more failure modes of the parts or equipment based on the classifications. Usage of a specially trained ANN to identify failure modes in this way provides improvements over traditional methods of detecting identifying failure modes, including more accurate identification of the failure modes, identification of failure modes on a much larger scale than is possible with humans identifying the failure modes, and identification of the failure modes much faster and/or at a much more rapid frequency than is possible with humans. The ANN can be realized through software, hardware, or a combination of software and hardware. The structure of the ANN can be a series of layers, with each layer including one or more artificial neurons arranged in one or more neuron arrays. Each of these neurons may include or represent a register, a microprocessor, and at least one input. Each neuron can produce an output, or activation, based on an activation function that uses the outputs of the previous layer and a set of weights as inputs. Each neuron in a neuron array can be connected to another neuron in the same layer or in another layer via one or more synaptic circuits. A synaptic circuit may include a memory for storing a synaptic weight. One example of this ANN may be a deep neural network having an input layer, an output layer, and a plurality of fully connected hidden layers. In some examples, the ANN (e.g., the control unit 106) can be implemented by an application-specific integrated circuit (ASIC) specially customized for the specific artificial intelligence application described herein and provide superior computing capabilities and reduced electricity consumption compared to traditional computers.

Training data can be generated by receiving continuous data at the control unit 106 and using the control unit 106 to discretize the continuous data. Optionally, the control unit 106 can be trained with a pretrained model. The training data or pretrained model may be received by the control unit 106 remotely over one or more networks. The training data may be historical data, which the neural network can use to learn patterns in the visual representations of the data to identify or detect the same (or similar) patterns in other data collected from other parts or equipment. The trained ANN monitors additional visual representations of data to identify patterns and classify the patterns. If the trained ANN detects one or more patterns, the trained ANN can classify the pattern(s) to generate classification data which can be output to a user and/or used to re-train the ANN. For example, the classification data may identify the type or mode of a potential or upcoming failure of the part or equipment.

The ANN of the control unit 106 can continue to learn (e.g., be re-trained) to improve identification of patterns in data visualizations, as well as improve the classification of the identified patterns. This continued learning can occur by, for example, changing the output generated by one or more of the neurons responsive to receiving the same input (e.g., a neuron produces a different output after the change), changing the activation function of one or more neurons, changing one or more of the weights, and/or changing one or more of the connections between the neurons (or which neurons are connected with each other). Changing one or more of these factors can cause the ANN to produce a different output (e.g., a different pattern is identified and/or a different classification is selected) than prior to the change.

Returning to the description of the method 200, at 210, the class of the reliability pattern that is identified at 208 is mapped to a failure mode. As described above, a failure mode can include one of multiple quantitatively distinct unreliability features in a reliability pattern that includes a trend and/or a known physical reason producing the quantitative feature producing the failure(s) of interest. Examples of failure modes can include an infant/early mortality feature, a wear-out feature, a random failure feature, or the like. Examples of the physical reasons can include known defects, installation errors, metal fatigue, wear beyond limits, etc. Other types of failure modes and/or physical reasons may exist or be used, and the preceding lists are not exhaustive lists of all failure modes and/or physical reasons. Different classifications of reliability patterns may be associated with different failure modes (e.g., in the memory 112). The control unit 106 can map the classification that is determined at 208 to the failure mode using these stored associations.

At 212, one or more responsive actions are identified based on the classification that is determined. For example, the control unit 106 may determine that the identified failure mode for the part or equipment being examined requires that the examined part/equipment or a combination of the examined part/equipment and another part/equipment be replaced. As another example, the control unit 106 may determine that the identified failure mode requires the part or equipment be inspected and/or maintained (e.g., serviced). If no failure mode was identified and the reliability pattern was classified as such, then the control unit 106 may determine that the part or equipment does not need to be replaced, serviced, or inspected. Different combinations of (a) failure mode classifications, categories, or buckets and (b) parts/equipment may be stored in the memory 108. The control unit 106 can reference this information to determine which or what actions to take based on the category or bucket in which each part or equipment is labeled or associated.

For example, one category or bucket may be associated with replacement of the parts or equipment in that category or bucket. Another category or bucket can be associated with replacement of another part or equipment (other than the examined part or equipment). Another category or bucket can be associated with inspection of the parts or equipment in that category or bucket. Another category or bucket can be associated with maintenance of the parts or equipment in that category or bucket. Another category or bucket can be associated with changing an inspection or maintenance schedule of the parts or equipment in that category or bucket. Another category or bucket can be associated with communicating an alert or warning (e.g., via the communication device 102) to an operator or other personnel to notify them of the classification of the parts or equipment in that category or bucket.

At 214, a decision is made as to whether the responsive action that is identified will avoid negative outcomes. For example, if the responsive action for a category or bucket is to replace a part or equipment, the control unit 106 can examine the category or bucket of the replacement part or equipment to determine whether the replacement part or equipment is likely to fail soon. The control unit 106 can recommend a longer operational lifetime for the part or equipment, or even recommend that the part or equipment continue to be used until the part or equipment fails (referred to as run-to-failure) if the probability of infant mortality for that part or equipment outweighs (e.g., is greater than) the probability of failure later in life of the part or equipment. As another example, if the replacement part or equipment is categorized in the infant mortality category, then that replacement part or equipment should not be used as that replacement part or equipment also is likely to fail. As a result, flow of the method 200 can proceed toward 216. At 216, another, alternate responsive action is identified. For example, the control unit 106 may direct the examined part or equipment to be replaced but with another part or equipment (e.g., one that is not in a failure mode category).

If it is decided at 214 that the identified responsive action will avoid negative outcomes, then flow of the method 200 can proceed toward 218. At 218, the responsive action is implemented. For example, the responsive action identified at 212 (if no negative outcome is identified) or the alternate responsive action identified at 216 (if a negative outcome is identified) is implemented.

The control unit 106 can send a control signal to an external system 114 that can implement the responsive action. This external system 114 can represent one or more output devices (e.g., electronic displays, speakers, etc.) that can notify personnel of the replacement, inspection, etc. of the part or equipment. The external system 114 can represent one or more robotic systems that can autonomously move to obtain a replacement part or equipment for the examined part or equipment. The external system 114 can represent an inventory management system that can automatically order or otherwise obtain additional replacement parts or equipment based on failure rates of the parts or equipment that are classified and lead times for obtaining those additional replacement parts or equipment.

The responsive action that is implemented can provide a practical application of the failure mode that is identified by changing a state or condition of the component being examined and/or the powered system. For example, the responsive action can replace the component (thereby changing the state of the powered system) to allow the powered system to continue operating and reduce downtime of the powered system. As another example, the responsive action can inspect and repair the component to allow the component to continue operating and reduce downtime of the powered system.

As another example of a responsive action, the classification system 100 can plan or schedule maintenance of the powered system (including equipment and parts) by identifying the equipment and parts that may require a more proactive maintenance schedule based on the reliability pattern classification of those parts. For example, the control unit 106 can send a control signal to the external system 114 to increase the frequency of maintenance and/or shorten a delay before the next maintenance of equipment or parts that are classified as requiring maintenance sooner.

As another example of a responsive action, the control unit 106 can identify reliability patterns in the visual representations associated with equipment and parts to determine whether the equipment or parts have product design flaws. These flaws may not be identified from manual inspection but may be identified by the control unit 106 using the model 110. For example, the control unit 106 may detect a pattern in the visual representation of the raw data for equipment or a part that indicates the equipment or part needs to be repaired or replaced sooner than expected, especially if the equipment or part is new. The control unit 106 can determine that this pattern indicates a design flaw in the equipment or part, and can send a control signal to the external system 114 to cause the external system 114 to prevent any more of the equipment or parts from being distributed or used in other powered systems. For example, the external system 114 may be an inventory tracking system that prevents the equipment or parts from being distributed for use in other powered systems.

As another example of a responsive action, the control unit 106 can identify reliability patterns in the visual representations associated with equipment and parts to determine whether one or more processes can be improved. For example, the equipment and parts therein may be inspected and maintained according to one or more schedules and/or procedures. The control unit 106 may use the model 110 to identify equipment and parts that are classified for one or more failure modes earlier than the equipment or parts should normally be. The control unit 106 can send a control signal to the external system 114, which represent a scheduling or dispatch system that can change the schedule(s) and/or procedures. The control unit 106 can then re-evaluate the reliability patterns of equipment and/or parts after the schedules and/or procedures are modified to determine whether the schedules and/or procedures should be modified again. Over time, this can ensure that the maintenance schedules and procedures are improving, rather than restricting or damaging, the useful lives of the equipment and parts used in powered systems.

As another example of a responsive action, the control unit 106 can identify reliability patterns in the visual representations associated with equipment and parts to determine whether one or more suppliers of the equipment or parts is providing less reliable equipment or parts (compared with one or more other suppliers). For example, the control unit 106 can categorize different equipment or parts according to the source or supplier that provided the equipment or parts. Within each supplier category, the control unit 106 can examine the visual representations of the raw data for the equipment and parts provided by or obtained from the supplier associated with that category. Multiple suppliers may provide the same equipment or parts, and the control unit 106 can determine whether the equipment or parts from any suppliers are associated with more failure modes than other suppliers, more of a particular type of failure mode (e.g., infant mortality) than other suppliers, etc. Based on this comparison, the control unit 106 can communicate a control signal to the external system 114. Responsive to receiving this control signal, the external system 114 can stop acquiring more equipment or parts from that supplier and/or can prevent equipment or parts from that supplier from being removed from inventory and installed on any powered systems.

As another example of a responsive action, the control unit 106 can identify reliability patterns in the visual representations associated with equipment and parts to determine whether any anomalies are detected. For example, the control unit 106 can examine the visual representations for multiple copies of the same part or same equipment. The control unit 106 can categorize these copies according to age, usage history, maintenance history, etc. The control unit 106 can then compare the failure modes of the parts or equipment within each of these categories to determine whether any part or equipment is exhibiting unusual failure modes. For example, if one part of a group of many parts with the same age, usage history, and/or maintenance history is found to have a failure mode that the other parts in that category do not, the control unit 106 may identify that part as an anomaly. The control unit 106 can communicate a control signal to the external system 114 to have the external system 114 schedule removal and replacement of that part, or to automatically remove the part.

As another example of a responsive action, the control unit 106 can improve the efficiency and productivity of manual inspections of parts or equipment. The control unit 106 can examine the visual representations of raw data for parts or equipment to identify reliability patterns associated with failure modes. This can be performed as an initial filter so that the control unit 106 can then identify and priority those parts or equipment for manual inspection before or in place of other equipment or parts not having the reliability patterns associated with the failure modes. The control unit 106 can send a control signal to the external system 114, which can sort or gather these parts or equipment for manual inspection prior to the other parts or equipment.

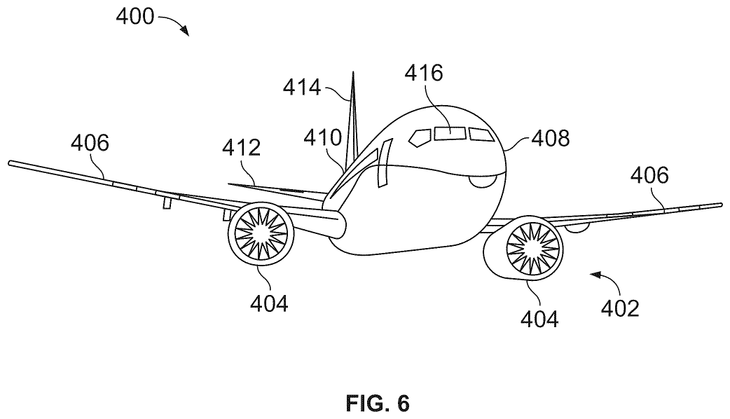

FIG. 6 illustrates a perspective front view of one example of a powered system 400. The powered system 400 can be an aircraft or another system, as described above. The powered system 400 includes a propulsion system 402 that includes engines 404, for example. Optionally, the propulsion system 402 may include more engines 404 than shown. The engines 404 are carried by wings 406 of the aircraft 400. In other examples, the engines 404 may be carried by a fuselage 408 and/or an empennage 410. The empennage 410 may also support horizontal stabilizers 412 and a vertical stabilizer 414. The fuselage 408 of the aircraft 400 defines an internal cabin 416, which includes a flight deck or cockpit, one or more work sections (for example, galleys, personnel carry-on baggage areas, and the like), one or more passenger sections (for example, first class, business class, and coach sections), one or more lavatories, and/or the like. The aircraft 400 can be sized, shaped, and configured differently than shown in FIG. 4. The pilot or other operators described herein may be onboard the aircraft or may be off-board the aircraft and remotely monitoring and/or controlling the aircraft.

Further, the disclosure comprises examples according to the following clauses:
Clause 1: A reliability pattern classification system comprising:
a communication device configured to obtain historical data indicative of usage of a component of a powered system; and
a control unit configured to create a visual representation of the historical data, identify one or more reliability patterns within the visual representation using a vision-based, deep learning model, categorize a failure mode of the component based on the one or more reliability patterns that are identified, and implement one or more responsive actions to change a state of condition of the component, the powered system, or both the component and the powered system.
Clause 2: The reliability pattern classification system of Clause 1, wherein the communication device is configured to obtain raw data as the historical data and the control unit is configured to create the visual representation from the raw data.
Clause 3: The reliability pattern classification system of Clause 2, wherein the raw data has not been changed, formatted, altered, cleaned, sorted, converted, or structured following creation of the raw data.
Clause 4: The reliability pattern classification system of Clause 1, wherein the control unit is configured to identify the one or more reliability patterns using visual inspection of the visual representation of the historical data.
Clause 5: The reliability pattern classification system of Clause 1, wherein the historical data includes maintenance information about the component.
Clause 6: The reliability pattern classification system of Clause 1, wherein the control unit is configured to use the vision-based, deep learning model that was trained using one or more of synthetic data or human-labeled data to identify the one or more reliability patterns.
Clause 7: The reliability pattern classification system of Clause 1, wherein the control unit is an artificial neural network trained using a pre-trained model for identifying the patterns in the visual representations.
Clause 8: The reliability pattern classification system of Clause 1, wherein the control unit is configured to implement the one or more responsive actions based on the failure mode that is categorized.
Clause 9: The reliability pattern classification system of Clause 1, wherein the one or more responsive actions include one or more of replacing the component, repairing the component, identifying a product design flaw in the component, changing a maintenance process associated with the powered system or the component, identifying and avoiding further supply from a supplier of the component, identifying the component as an anomaly, or changing a priority of manual inspection of the component relative to one or more other components.

Clause 10: A method comprising:
obtaining historical data indicative of usage of a component of a powered system;
creating a visual representation of the historical data;
identifying one or more reliability patterns within the visual representation using a vision-based, deep learning model;
categorizing a failure mode of the component based on the one or more reliability patterns that are identified; and
implementing one or more responsive actions to change a state of condition of the component, the powered system, or both the component and the powered system.
Clause 11: The method of Clause 10, wherein the historical data that is obtained is raw data and the visual representation is created from the raw data.
Clause 12: The method of Clause 10, wherein the one or more reliability patterns are identified using visual inspection of the visual representation of the historical data.
Clause 13: The method of Clause 10, wherein the historical data includes maintenance information about the component.
Clause 14: The method of Clause 10, wherein the one or more reliability patterns are identified using the vision-based, deep learning model that was trained using one or more of synthetic data or human-labeled data.
Clause 15: The method of Clause 10, wherein identifying the one or more reliability patterns and categorizing the failure mode is performed using an artificial neural network that is trained using a pre-trained model for identifying the patterns in the visual representations.
Clause 16: The method of Clause 10, wherein the one or more responsive actions that are implemented is based on the failure mode that is categorized.
Clause 17: The method of Clause 10, wherein the one or more responsive actions include one or more of replacing the component, repairing the component, identifying a product design flaw in the component, changing a maintenance process associated with the powered system or the component, identifying and avoiding further supply from a supplier of the component, identifying the component as an anomaly, or changing a priority of manual inspection of the component relative to one or more other components.
Clause 18: A method comprising:
creating visual representations of raw maintenance data of components of an aircraft;
visually identifying patterns within the visual representations using a vision-based, deep learning model;
categorizing the components into different failure modes based on the patterns that are visually identified; and changing a state of the aircraft based on at least one of the failure modes into which at least one of the components is categorized.
Clause 19: The method of Clause 18, wherein visually identifying the patterns and categorizing the components is performed using an artificial neural network that is trained using a pre-trained model for identifying the patterns within the visual representations.
Clause 20: The method of Clause 18, wherein the raw maintenance data includes one or more of flight hours of the components, flight cycles of the components, or days on wing of the components without altering the raw maintenance data.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to”perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein. ” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A reliability pattern classification system comprising:
a communication device configured to obtain historical data indicative of usage of a component of a powered system; and
a control unit configured to create a visual representation of the historical data, identify one or more reliability patterns within the visual representation using a vision-based, deep learning model, categorize a failure mode of the component based on the one or more reliability patterns that are identified, and implement one or more responsive actions to change a state of condition of the component, the powered system, or both the component and the powered system.

2. The reliability pattern classification system of claim 1, wherein the communication device is configured to obtain raw data as the historical data and the control unit is configured to create the visual representation from the raw data.

3. The reliability pattern classification system of claim 2, wherein the raw data has not been changed, formatted, altered, cleaned, sorted, converted, or structured following creation of the raw data.

4. The reliability pattern classification system of claim 1, wherein the control unit is configured to identify the one or more reliability patterns using visual inspection of the visual representation of the historical data.

5. The reliability pattern classification system of claim 1, wherein the historical data includes maintenance information about the component.

6. The reliability pattern classification system of claim 1, wherein the control unit is configured to use the vision-based, deep learning model that was trained using one or more of synthetic data, or human-labeled data to identify the one or more reliability patterns.

7. The reliability pattern classification system of claim 1, wherein the control unit is an artificial neural network trained using a pre-trained model for identifying the patterns in the visual representations.

8. The reliability pattern classification system of claim 1, wherein the control unit is configured to implement the one or more responsive actions based on the failure mode that is categorized.

9. The reliability pattern classification system of claim 1, wherein the one or more responsive actions include one or more of replacing the component, repairing the component, identifying a product design flaw in the component, changing a maintenance process associated with the powered system or the component, identifying and avoiding further supply from a supplier of the component, identifying the component as an anomaly, or changing a priority of manual inspection of the component relative to one or more other components.

10. A method comprising:
obtaining historical data indicative of usage of a component of a powered system;
creating a visual representation of the historical data;
identifying one or more reliability patterns within the visual representation using a vision-based, deep learning model;
categorizing a failure mode of the component based on the one or more reliability patterns that are identified; and
implementing one or more responsive actions to change a state of condition of the component, the powered system, or both the component and the powered system.

11. The method of claim 10, wherein the historical data that is obtained is raw data and the visual representation is created from the raw data.

12. The method of claim 10, wherein the one or more reliability patterns are identified using visual inspection of the visual representation of the historical data.

13. The method of claim 10, wherein the historical data includes maintenance information about the component.

14. The method of claim 10, wherein the one or more reliability patterns are identified using the vision-based, deep learning model that was trained using one or more of synthetic data or human-labeled data.

15. The method of claim 10, wherein identifying the one or more reliability patterns and categorizing the failure mode is performed using an artificial neural network that is trained using a pre-trained model for identifying the patterns in the visual representations.

16. The method of claim 10, wherein the one or more responsive actions that are implemented is based on the failure mode that is categorized.

17. The method of claim 10, wherein the one or more responsive actions include one or more of replacing the component, repairing the component, identifying a product design flaw in the component, changing a maintenance process associated with the powered system or the component, identifying and avoiding further supply from a supplier of the component, identifying the component as an anomaly, or changing a priority of manual inspection of the component relative to one or more other components.

18. A method comprising:
creating visual representations of raw maintenance data of components of an aircraft;
visually identifying patterns within the visual representations using a vision-based, deep learning model;
categorizing the components into different failure modes based on the patterns that are visually identified; and
changing a state of the aircraft based on at least one of the failure modes into which at least one of the components is categorized.

19. The method of claim 18, wherein visually identifying the patterns and categorizing the components is performed using an artificial neural network that is trained using a pre-trained model for identifying the patterns within the visual representations.

20. The method of claim 18, wherein the raw maintenance data includes one or more of flight hours of the components, flight cycles of the components, or days on wing of the components without altering the raw maintenance data.
